(19) United States
(12) Patent Application Publication
(10) Pub. No.: US 2016/0335371 A1
(43) Pub. Date: Nov. 17, 2016

(54) SYSTEM AND METHOD FOR QUERYING GRAPHS DISTRIBUTED OVER MULTIPLE MACHINES

(71) Applicant: General Electric Company, Schenectady, NY (US)

(72) Inventor: Bharath Rao, San Ramon, CA (US)

(21) Appl. No.: 14/713,293

(22) Filed: May 15, 2015

(51) Int. Cl. G06F 17/30

(52) U.S. Cl. CPC G06F 17/30958; G06F 17/30324; G06F 17/303; G06F 17/30545

(57) ABSTRACT

A method to perform query operations on nodes of large graphs distributed across multiple machines by applying a graph-query language that implements lazy evaluation techniques are disclosed. A method includes receiving a graph query expression from a client, wherein a graph comprises a plurality of edges linking a plurality of vertices, receiving a first request for evaluating the graph query expression, evaluating a partial result set for the graph query expression, and sending the partial result to the client. The partial result including at least one of a successor query and a predecessor query, wherein the successor query and the predecessor query enable evaluation of the graph query expression at a point in the graph query expression where the partial result evaluation terminated. A system and non-transitory computer readable medium are also disclosed.

### BACKGROUND

A graph is a representation of a set of objects where some pairs of the objects are connected by links. Each interconnected object is represented by a mathematical abstraction called a vertex, and at least one link that connects a pair of vertices is called an edge. An edge provides a relationship between a pair of vertices. Typically, a graph is depicted in diagrammatic form as a set of dots for the vertices, joined by lines or curves for the edges.

Graphs can be either directed or undirected. A directed graph is one where the relationship between vertices is asymmetric. For example, if the vertices represent employees of an enterprise, and one employee knows of another (e.g., the custodian knows the name of the corporate president), then the graph would be a directed graph (the custodian's knowledge of the corporate president does not necessarily mean the president knows the custodian). An example of a directed graph could be one that represents employees working together on the same project.

### BRIEF DESCRIPTION OF THE DRAWINGS

FIG. 1 depicts an exemplary block diagram of the graph system, in accordance with embodiments;

FIG. 2 depicts a diagram of an exemplary graph, in accordance with embodiments;

FIG. 3 depicts a diagram of an exemplary trie, in accordance with embodiments;

FIG. 4(a) depicts a diagram of an exemplary compact trie, in accordance with embodiments;

FIG. 4(b) depicts another diagram of an exemplary compact trie, in accordance with embodiments;

FIG. 5(a) depicts an exemplary diagram of cleaving two new pages from a current page, in accordance with embodiments;

FIG. 5(b) depicts another exemplary diagram of cleaving two new pages from a current page, in accordance with embodiments;

FIG. 6 depicts an exemplary diagram for allocating a page, in accordance with embodiments;

FIG. 7 depicts an exemplary diagram for returning a newly freed page to a free page list in accordance with embodiments;

FIG. 8 depicts another exemplary graph, in accordance with embodiments;

FIG. 9 depicts exemplary pages that store a trie of the graph 800 in accordance with embodiments;

FIG. 10 depicts another exemplary graph, in accordance with embodiments;

FIG. 11 depicts exemplary pages that store a trie of the graph 1000, in accordance with embodiments;

FIG. 12 depicts an exemplary process of querying a graph, in accordance with embodiments;

FIG. 13 depicts an exemplary diagram of storing large graph data across multiple hosts, in accordance with embodiments; and

FIG. 14 depicts an exemplary computer architecture that may be used for the graph system, in accordance with embodiments;

### DETAILED DESCRIPTION

Embodying systems and methods perform query operations on nodes of large graphs distributed across multiple machines by applying a graph-query language that implements lazy evaluation techniques (e.g., delaying evaluation or a term until its value is needed). In accordance with implementations, data can be generated as it is consumed, thus saving computing space. When a first result in response to a graph query is required, the system evaluates a cursor/pointer and returns the first result. If a second result is required, the system then proceeds to evaluate the second result. This provides zero latency in returning results. In one implementation, relationships between vertices and edges can be modeled for directed graphs with labeled edges.

The data on a large graph may be stored across multiple machines. For instance, a first machine can store data field1 and data field2, while a second machine can store data field2 and data field3. Embodying systems can optimize the query by returning results from multiple machines and merging the individually returned results to produce one result.

Additionally, embodying systems and methods can update a graph by adding and/or or removing an edge. When adding an edge, the system can send the information regarding the additional edge to any machine(s). When removing an edge, the system sends the information regarding the deleted edge to all the machines.

In accordance with embodiments, systems and methods implement queries of basic ontology reasoning graphs (BORG) that model pairwise relations between vertices (or nodes) objects linked together by edges. The runtime system of BORGs can include a storage engine, an association engine (three permutations), a query engine (simple queries) and a cloud inference engine (complex queries). Evaluating a query for a graph can include memory mapping the graph (using RAM), evaluating the graph expression language (GEL) as reverse polish notation (RPN)—i.e., a mathematical notation in which every operator follows all of its operands, and returning the results.

Memory mapping means that data structures are unified—i.e., a change in memory can include automatically updating the change on a persistent store (e.g., hard drive disk, etc.) and vice-versa. Utilizing RPN ensures that operators in a graph expression have the same performance characteristics. In accordance with implementations, methods can include using amortized aggregates (analyzing algorithms to consider the entire sequence of operations) to form and maintain the results as part of a load.

In accordance with embodiments, a computer-implemented method includes receiving a graph query expression, where a graph includes a plurality of edges and a plurality of vertices, providing a first result based on evaluating the graph query expression, receiving a consumption indicator of the first result, and providing a second result based on the consumption indicator.

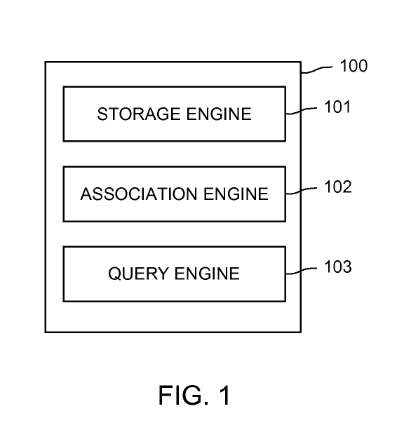

FIG. 1 depicts an exemplary block diagram of graph system 100, in accordance with embodiments. The graph system 100 includes a storage engine 101, an association engine 102, and a query engine 103. The storage engine 101 stores data of vertices and edges into a persistent store. A persistent store refers to any type of data storage including, but not limited to, a key value store and an abstract network store. While FIG. 1 illustrates only one storage engine 101, it is understood that vertices and edges of a graph can be stored across multiple storage engines. According to embodiments, the storage engine 101 stores vertices and edges based on a memory mapped trie over a distributed file system.

A trie is an ordered tree data structure that stores data by using a key to identify a piece of data, and further a value that holds any additional data associated with the key. A trie can include a primary vertex that is linked by one or more edges to a secondary vertex, where the secondary vertex has a common prefix of a string associated with the primary vertex. The distributed file system may include, but is not limited to LUSTRE™ (a type of parallel distributed file system) and the Hadoop Distributed File System (HDFS).

The association engine 102 provides two types of permutations of a vertex-edge-vertex that are stored in the storage engine 101. Storing permutations allows graph system 100 to query a graph without explicit indexing. The need to index and re-index a graph after the graph is constructed and in use is a barrier to performance. In accordance with some embodiments, association engine 102 can provide a third type of permutation of a vertex-edge-vertex that is stored in the storage engine 101 to support queries.

The three types of permutations are explained in greater detail below. While only three types of permutations that are associated with the association engine 102 are discussed herein, it is understood that any number of permutations and/or a combination of one or more types of permutations may be used without deviating from the scope of the present subject matter. The query engine 103 processes a query that is provided to the graph system 100.

According to embodiments, the graph system can employ a directed graph where an edge has a direction. A directed edge is typically represented using an arrow connecting its two vertices. The vertex connected to the origin of the arrow is termed the subject and the vertex connected to the destination of the arrow is termed the object. The edge itself is termed the predicate. A predicate is typically used to represent an attribute of its subject or its relationship to its object. A directed edge forms the smallest building block of a directed graph and may be denoted as (subject, predicate, object) and is termed a triple. A graph containing multiple edges and typically edges representing different predicates between two vertices is generally termed as a multi-graph.

In some implementations, graph system 100 can be based on an open-world assumption—i.e., anything that is not part of the graph under evaluation is assumed to be an unknown, rather than non-existent. Embodying graph systems may be represented in various ways, such as an adjacency list or an incidence list. An incidence list provides a list of strings, where each string includes one or more delimiters, such as sequence of one or more characters to separate a subject, a predicate, and an object. An adjacency list provides a list of edges and connected vertices for each vertex.

According to embodiments, the graph system may use various symbols (e.g., the → symbol) or any symbol that is not part of an input alphabet as a delimiter. For example, for unicode universal character set (UCS) transformation format-8 bit (UTF-8) string, bytes 0xF5 to 0xFF can be used as delimiters. Additional information (e.g., a tag, a timestamp, etc.) can be associated to an edge to indicate additional functionality. Further, an end of a string can be marked with a marker such as the null byte, as indicated by the ⊥ symbol.

Two exemplary triples may be stored as the following strings:
Alice→likes→Coffee⊥
coffe→contains→Caffeine⊥

In the first triple, “Alice” is the subject; “likes” is the predicate and “Coffee” is the object. The triple asserts the fact that the vertex “Alice” has a “likes” relationship to the vertex “Coffee.” Additionally, in the second triple, “Coffee” is the subject, and “contains” is the predicate to the object “Caffeine.” This is illustrated below in Table 1:

TABLE 1

| Subject | Predicate | Object |
|---|---|---|
| Alice | likes | Coffee |
| Coffee | contains | Caffeine |

Operators are introduced in Table 2, which can be used to form graph expressions.

TABLE 2

| Operator | Name | Type |
|---|---|---|
| > | Forward Hop | Graph |
| < | Backward Hop | Graph |
| = | Flipped Backward Hop | Graph |
| , | List | Data |
| .. | Range | Data |
| : | Intersection | Set |
| \| | Union | Set |
| ! | Relative Complement (set | Set |
| | difference) | |

Each graph operator takes two operands, the first being a vertex and the second being a predicate and returns a set of vertices. The exception is the flipped Backward Hop, which is simply the Backward Hop operator with its operands reversed for convenience. The list and the range operators are simply shorthand to specify a set of vertices. All set operators take two sets of vertices and return a set of vertices as result. Operators may be combined with the results of previous operations to form long expressions.

In addition, other set operators may be defined as necessary, which although not explained herein should be considered to be within the means of a person of ordinary skill in the arts to implement.

A graph expression language (GEL) implemented by embodying systems and methods can be based on the following approaches:

The forward hop operator >takes a set of vertices as the first argument and a predicate as the second argument and returns all vertices that lead from the input vertex set which have an outgoing edge with the predicate label passed as the second argument. When the first argument is a set with a single vertex, the query may be expressed thus:
subject>predicate

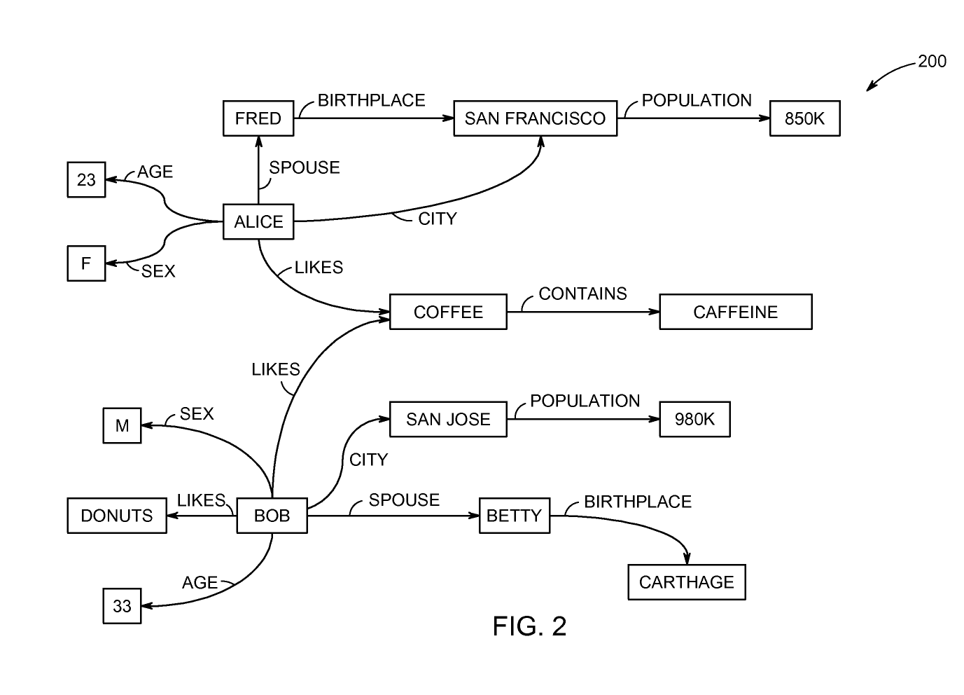

From FIG. 2, we may query all items liked by Alice thus:
Alice>likes

The above should return “Coffee” as a result.

The backward hop operator< is similar except that the direction of the edge is inbound.

From FIG. 2, we may query all subjects that like Coffee thus:
Coffee<likes

Using the alternate syntax, we could also query the same thus:
likes=Coffee

hops on above may be queried thus is the A graph query expression that indicates a query for a subject that has a predicate to an object may be defined as follows:
predicate=object

where the : symbol represents the arrow out of the predicate into the object in the graph. Referring to the above string, an exemplary query expression is defined as follows:
likes=Coffee

The result of the above query expression is the subject “Alice”.

Another graph query expression that indicates a query for an object with a corresponding subject and predicate:
subject>predicate

where the > symbol represents the arrow leading out of the subject with the said predicate. Referring to the above string, an exemplary query expression is defined as follows:
Coffee>contains

The result of the above query expression is the object “Caffeine”. This may be visualized as hopping from the subject vertex “coffee” on to the edge labeled “contains” and returning the object vertex as the result.

Operations can be chained just as in mathematical expressions to extract larger subgraphs. These may be presented in a tabular format as shown below. Since this does not represent a real table, it is termed “synthetic table”

For the query likes=Coffee>city>population

| | | |
|---|---|---|
| Alice | San Francisco | 850K |
| Bob | San Jose | 980K |

Graph queries may be combined using the set operators. For example:

| | |
|---|---|
| likes=Coffee : likes=Donuts | all subjects who like both Coffee and Donuts |
| likes=Coffee\|likes=Donuts | all subjects who like either Coffee or Donuts |
| likes=Coffee!likes=Donuts | all subjects who like Coffee but not Donuts |

The list operator “,” may be used to specify multiple predicates to branch on
Alice>age,sex,spouse

| | | | |
|---|---|---|---|
| Alice | 23 | F | Fred |

Triangular relationships can be detected using an intersection of branching and edge hopping.
likes=Coffee>spouse>birthplace:likes=Coffee>spouse,city

| | | |
|---|---|---|
| Alice | Fred | San Francisco |

FIG. 2 depicts a diagram of an exemplary graph 200, in accordance with embodiments. The graph 200 includes vertices 201-218 and edges 251-258 that provide directed links between vertices 201-218. According to embodiments, a graph query expression of the graph 200 defines graph traversal and subgraph extraction by means of edge hopping. An exemplary query expression is illustrated as follows:
edge 251=vertex 204>edge 252>edge 253.

As explained above, for the operation edge 251:vertex 204 of the query expression, the results are vertex 201 and vertex 202. Therefore, the query expression can be represented as:
vertex 201>edge 252>edge 253, and
vertex 202>edge 252>edge 253.

For vertex 201, edge 252 is a predicate to the object vertex 203, and in turn vertex 203 is a subject of the predicate edge 253 to the object vertex 209. For vertex 202, edge 252 is a predicate to the object vertex 205, and in turn vertex 205 is a subject of the predicate edge 253 to the object vertex 210. Therefore, the results of the above graph query expression by edge hopping is illustrated in Table 3:

TABLE 3

| | | |
|---|---|---|
| vertex 201 | vertex 203 | vertex 209 |
| vertex 202 | vertex 205 | vertex 210 |

According to embodiments, a graph query expression of the graph 200 combines subgraphs by various Boolean functions (e.g., OR, AND). An exemplary query expression for an OR function is illustrated as follows:
(edge 251=vertex 204|edge 251=vertex 206)>edge 255.

As explained above, for the operation edge 251=vertex 204 of the query expression, the results are vertex 201 and vertex 202. Similarly, for the operation edge 251=vertex 206 of the query expression, the results are vertex 201 and vertex 202. Since this is an OR function (represented by the | symbol), both vertices 201 and 202 are included in the results. Therefore, the query expression can be represented as:
vertex 201>edge 255, and
vertex 202>edge 255.

For vertex 201, edge 255 is a predicate to the object vertex 211. For vertex 202, edge 255 is a predicate to the object vertex 212. Therefore, the results of the above graph query expression for the OR function are illustrated in Table 4:

TABLE 4

| | |
|---|---|
| vertex 201 | vertex 211 |
| vertex 202 | vertex 212 |

An exemplary query expression for an AND function is illustrated as follows:
(edge 251=vertex 204: edge 255=vertex 212)>edge 254.

As explained above, for the operation edge 251=vertex 204 of the query expression, the results are vertex 201 and vertex 202. However, for the operation edge 255=vertex 212 of the query expression, the result is only vertex 202. Since this is an AND function (represented by the : symbol), only vertex 202 results from the intersection. Therefore, the query expression can be represented as:
vertex 202>edge 254.

Vertex 202 is a subject of the predicate edge 254 to the object vertex 208. Therefore, the results of the above graph query expression for the AND function are illustrated in Table 5:

TABLE 5

| | |
|---|---|
| vertex 202 | vertex 208 |

According to embodiments, a graph query expression of the graph 200 combines negation i.e., a set difference function. An exemplary query expression is illustrated as follows:
(edge 251=vertex 204 ! edge 255=vertex 211)>edge 254.

As explained above, for the operation edge 251=vertex 204 of the query expression, the results are vertex 201 and vertex 202. However, for the operation edge 255=vertex 211 of the query expression, the result is only vertex 201. Since this is a set difference function (represented by the “!” symbol) in the above query expression, only vertex 202 results from the query expression. Therefore the query expression can be represented as:
vertex 202>edge 254.

Vertex 202 is a subject of the predicate edge 254 to the object vertex 208. Therefore, the results of the above graph query expression for the AND NOT function are illustrated in Table 6:

TABLE 6

| | |
|---|---|
| vertex 202 | vertex 208 |

According to embodiments, a graph query expression of the graph 200 defines multiple edges from a vertex. An exemplary query expression is illustrated as follows:
edge 251=vertex 204>edge 255, edge 254, edge 252.

As explained above, for the operation edge 251=vertex 204 of the query expression, the results are the subjects vertex 201 and vertex 202. Therefore, the query expression can be represented as:
vertex 201>edge 255, edge 254, edge 252 and
vertex 202>edge 255, edge 254, edge 252.

For vertex 201, edge 255, edge 254 and edge 252 are the predicates to the respective objects vertex 211, vertex 207 and vertex 203. For vertex 202, edge 255, edge 254 and edge 252 are the predicates to the respective object vertices 212, vertex 208 and vertex 205. Therefore, the results of the above graph query expression that defines multiple edges from a vertex are illustrated in Table 7:

TABLE 7

| | | | |
|---|---|---|---|
| vertex 201 | vertex 211 | vertex 207 | vertex 203 |
| vertex 202 | vertex 212 | vertex 208 | vertex 205 |

According to embodiments, a graph query expression of the graph 200 provides a triangular relationship. An exemplary query expression is illustrated as follows:
edge 251=vertex 204>edge 255, edge 256: edge 251:vertex 204>edge 255>edge 256

As explained above, for the operation edge 251:vertex 204 of the query expression, the results are vertex 201 and vertex 202. Therefore, the query expression can be represented as:
vertex 201>edge 255, edge 256: vertex 201>edge 255>edge 256 and
vertex 202>edge 255, edge 256: vertex 201>edge 255>edge 256.

However, only vertex 202 has a triangular relationship, as illustrated in FIG. 2. As illustrated above, the operation vertex 201>edge 255, edge 256 of the query expression defines multiple edges from the vertex 201. Edge 255 and edge 256 are predicates to the respective objects vertex 211 and 213. On the other hand, the operation vertex 201>edge 255>edge 256 of the query expression defines edge hopping. Edge 255 and edge 256 are predicates to the respective objects vertex 211 and 213. The results of the above two portions match exactly in the intersection of the AND function. Therefore, the results of the above graph query expression for a triangular relationship are illustrated in Table 8:

TABLE 8

| | | |
|---|---|---|
| vertex 201 | vertex 211 | vertex 213 |

According to embodiments, a graph query expression of the graph 200 can be defined by one or more ranges. An exemplary query expression is illustrated as follows:
edge 251=vertex 204: edge 255=25 . . . 35>edge 254, edge 255.

As explained above, for the operation edge 251=vertex 204 of the query expression, the results are vertex 201 and vertex 202. Therefore, the query expression can be represented as:
vertex 201: edge 255=25 . . . 35>edge 254, edge 255 and
vertex 202: edge 255=25 . . . 35>edge 254, edge 255.

Edge 255 is a predicate to the objects vertex 212 and vertex 211. However, if vertex 212 represents a number 33 and vertex 211 represents a number 50, only vertex 212 is within the range of 25 to 35. Thus, there is no intersection region for the query expression regarding vertex 201, but there is an intersection region for the query expression regarding vertex 202. Vertex 202 is further a subject of the predicate edge 254 and edge 255 to the objects vertex 208 and vertex 212 respectively. Therefore, the results of the above graph query expression that is defined by a range are illustrated in Table 9:

TABLE 9

| | | |
|---|---|---|
| vertex 202 | vertex 208 | vertex 212 |

According to embodiments, a graph query expression of the graph 200 can be defined by an alias. An exemplary query expression is illustrated as follows:
alias 1=vertex 201>edge 254.

Where alias 1 may be used to substitute for the expression vertex 201>edge 254 and allow substitution in a query expression. For example, the expression alias 1>edge 257 is equivalent to vertex 201>edge 254>edge 257.

According to embodiments, when a blank identifier is used, the runtime generates an anonymous identifier and substitutes it as necessary. A blank identifier is a placeholder for a system generated identifier, and the server can choose to create a unique identifier for a graph query expression. An alternative for a blank identifier is to use a globally unique identifier (GUID) or other unique identifiers.

An edge that connects a pair of vertices together may be of a particular relationship type. According to embodiments, an edge is of a symmetric type. Vertices 217 and 218 are linked by a symmetric edge 258. Therefore, the following two exemplary query expressions are equivalent:
“vertex 217>edge 258” is equivalent to “vertex 218>edge 258.”

This allows the graph system to store only one side of a symmetric relationship and translate any query with edge 258 so that the query resolves correctly. For example, vertex 217>edge 258 becomes vertex 217>edge 258|vertex 217>edge 258. For example: when the predicate spouse is declared as symmetric, the system can translate the query thus:

A > spouse
A > spouse|A < spouse

According to another embodiment, an edge is of a transitive type. Vertices 202 and 208 are linked by edge 254, while vertices 208 and 217 are also linked by edge 254. Therefore, there is an transitive relation that vertex 202 and vertex 217 are linked by edge 254. The following exemplary query expressions are equivalent:
“vertex 202>edge 254[transitive:2]” is equivalent to “vertex 202>edge 254 vertex 202>edge 254>edge 254.”

For example, if in is declared to be transitive:

Given:

For example, if the predicate “in” is declared to be transitive, Given the following:
San Ramon in CA
CA in USA

The query San Ramon>in[transitive:2] would return

CA
USA

The term [transitive:2] denotes a hint to the system to traverse transitively to two levels deep. This can be achieved by rewriting the query San Ramon>in thus:
San Ramon>in|San Ramon>in>in

According to another embodiment, an edge is of an associative type. If edge 252 is associative with edge 253, the following exemplary query expressions are equivalent: “vertex 201>edge 253” is equivalent to “vertex 201>edge 252>edge 253.” For example, if the predicate “insuredBy” is declared to be associative with respect to the predicate ‘dependentOf’, then

If A insuredBy B and C dependentOf A, then the system would determine that C is insured by A. This is achieved by rewriting the query C>insuredBy thus:
C>insuredBy|C>dependentof>insuredBy

Triples could have subjects or objects that themselves are other triples. Such triples are called meta-triples. Meta triples are used to add context or additional information to a triple.

For example, if there is a triple: Jill likes Coffee. It could be annotated with the information that this was reported by Jack.

{Jill likes Coffee} reports Jack

In this case, an additional predicate and Object are saved with the triple

Jill→likes→Coffee→→reports→Jack⊥

Meta-triples may indicate which part of the triple they refer to using prefixes on the predicate:

Jill→likes→Coffee
→→reports→Jack
→→likes.strength→high
→→Coffee.type→Columbian.

These are queried in the same manner:

| | |
|---|---|
| likes=Coffee | Jill |
| reports=Jack | Jill likes Coffee |

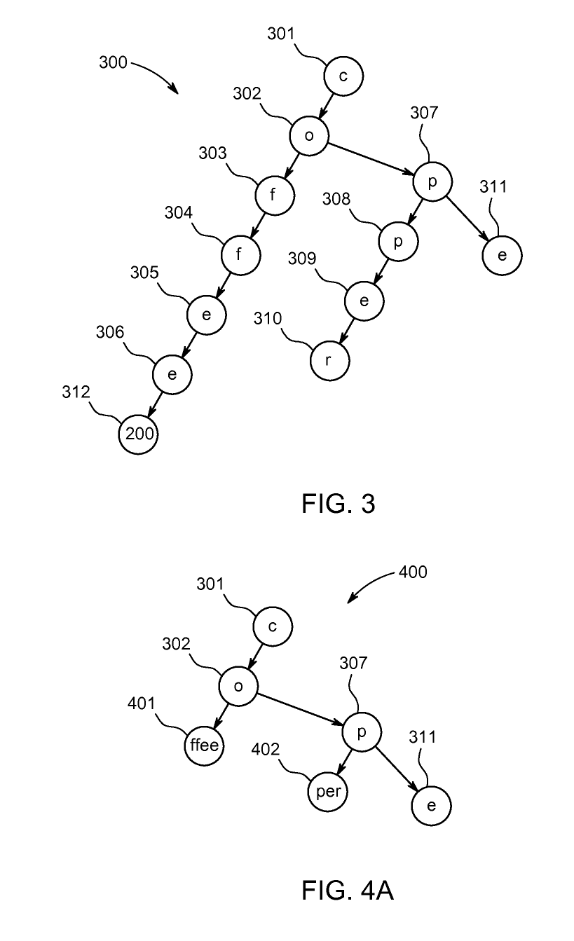

FIG. 3 illustrates a diagram of an exemplary trie 300, in accordance with embodiments. In embodiments, the trie 300 stores data whose keys are strings. Suppose the trie 300 stores three strings: coffee, copper and cope that share a common prefix “co”. Each vertex 301-306 from the trie 300 stores a respective character from the string “coffee” and all are connected together. For example, vertex 301 stores the character “c”, vertex 302 stores the character “o”, and vertex 301 is connected to vertex 302. Since the characters “co” are common to the strings coffee and copper, and characters “c” and “o” are stored in vertices 301 and 302 respectively, the trie 300 does not store “co” of the string “copper” again. Instead, the trie 300 stores each of the remaining characters “pper” of the string “copper” in a new branch of respective vertices 307-310. Similarly, as the characters “cop” are common among “copper” and “cope”, the trie 300 only stores the remaining character “e” from “cope” in an additional vertex 311.

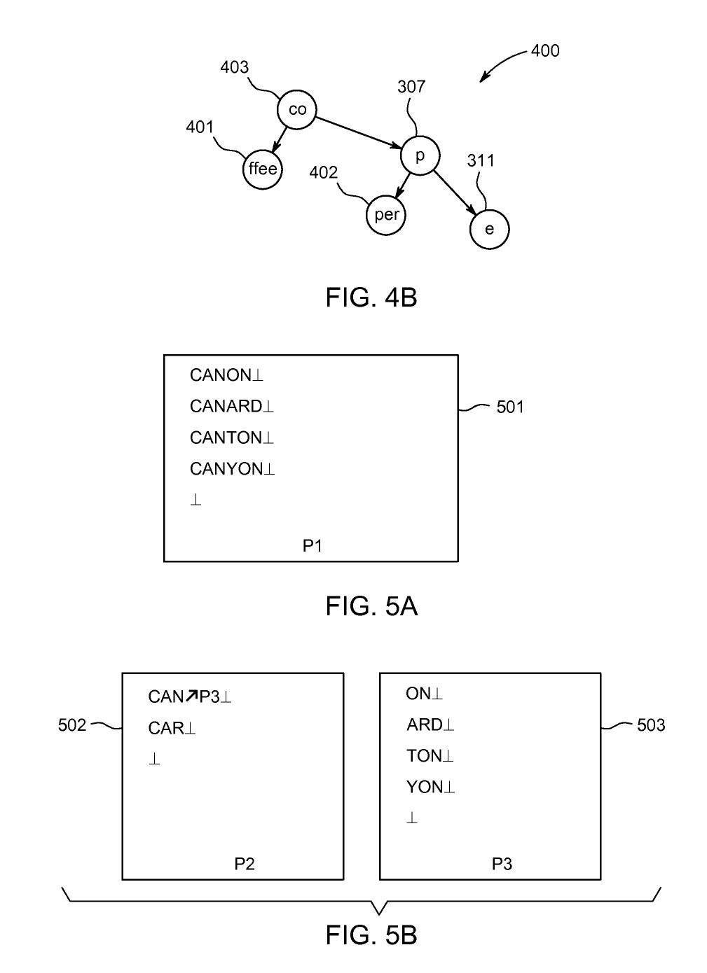

According to embodiments, the present storage system and method provides data optimization for a graph by using a compacted trie. FIGS. 4(a)-4(b) illustrate diagrams of an exemplary compact trie, in accordance with embodiments. The system stores three strings: coffee, copper and cope. As illustrated in FIG. 4(a), the trie 400 similarly stores each common characters “c” and “o” of “co” from the string “coffee” into respective vertices 301 and 302 (similar to FIG. 3). The trie 400 can further compact the characters “co” into a vertex 403, as illustrated in FIG. 4(b). Since there are no further characters that are branching out from the remaining characters “ffee” of the string “coffee”, the trie 400 stores the characters “ffee” into a single vertex 601. Similarly, as there no further characters that are branching out from the remaining characters “per” of the string “copper”, the trie 400 stores the characters “per” into a single vertex 402. This provides space optimization for the graph system and method.

In accordance with embodiments, the graph system stores strings in a trie data structure using a unified (i.e., memory mapping) in-memory storage and secondary storage structure. The graph system provides optimization for block storage of data, rather than character-by-character memory access as in traditional tries. A traditional system uses separate methods to store data on a secondary storage and load the data in a main memory and organize the data differently. For example, a system may use a relational database management system (RDBMS) or a key-value to store the data on a secondary storage, read the data into a main memory and construct a partial or full in-memory representation to perform operations on the data. The graph system optimizes the trie data structure for disk access rather than for CPU cache optimization. A main memory structure is typically optimized for CPU cache access, i.e., reduces cache misses and leverages optimal use of CPU cache lines. However, in most cases, secondary storage access (IO) is thousands of times slower than a main memory and most database accesses are IO bound. The graph system stores data optimized for IO in a format that can be used as both an incidence list and an adjacency list as a variant of a trie as described below.

An exemplary trie file of the graph system includes a header page that contains various fields such as a signature, a version number, and a list of free page banks. Each entry in a free page bank that contains free pages is a pointer to a free page, and each free page may in turn point to one or more free pages to form a linked list of free pages. An exemplary header page is illustrated in Table 10:

TABLE 10

| Signature | Version | Page size | Next free page |
|---|---|---|---|
| DA7ABA5E | 0x00000001 | 0x0000000C | 0x00000000 |
| Message | Digest | Trie | Data |
| 3A27B690 | 2215CF87 | Canon⊥Ca | nard⊥Can |

Referring to Table 10, the signature field indicates a hexadecimal byte sequence DA 7A BA 5E, the version field of a file format indicates a 4-byte integer 01, and the page size field indicates a hexadecimal 0x0C, i.e., a page size of 212. The next free page field indicates a hexadecimal 0x00 which indicates that the next free page starts at page zero and is a subsequent page after the header page. The message digest fields provide a compact representation of the contents of the page and acts as a quick way to compare contents of an entire page. When a page is changed, the message digest fields are recomputed and this ensures that any other concurrent service requests do not overwrite each other's changes for a page. The header page may include other fields as desired. According to embodiments, a process that accesses the data can check the version field to detect the size of the header and other parameters of the storage file or representation. In another embodiment, the message digest fields can be replaced with smaller or larger variants, checksums or sequence numbers, or any other mechanism to detect change.

According to embodiments, the graph system stores a trie on a single page that contains all the strings in a sorted order. As new strings are added, the graph system inserts the new strings in a sorted order. If the page cannot store a new string, the graph system cleaves a new page from the current page. FIGS. 5(a)-5(b) illustrate exemplary diagrams of cleaving two new pages from a current page, in accordance with embodiments. The ⊥ symbol indicates the end of a string (e.g., Canon ⊥). The graph system may further assign two successive ⊥ symbols to indicate an end of a page (e.g., Canyon⊥⊥ on page P1 501). Referring to FIG. 5(a), the graph system stores a trie that includes four strings, “Canon”, “Canard”, “Canton”, and “Canyon” on Page P1 501. If the graph system tries to add a new string “Car” to page P1 501 but page P1 501 cannot store any more new strings, the graph system cleaves page P1 501 into two pages P2 502 and P3 503 as illustrated in FIG. 5(b).

Since the prefix “Can” is common to the strings “Canon”, “Canard”, “Canton”, and “Canyon”, the graph system stores the characters “Can” on page P2 502, as indicated by the string “Can [symbol] P3”. The graph system adds a pointer from the prefix “Can” that indicates that a portion of the trie is continued on a separate page. According to embodiments, the pointer is indicated by a [symbol] symbol and the notation [symbol] P3 indicates that a portion of the trie is continued on page P3 503. According to embodiments, the graph system may use a byte between 0xF5 to 0xFF to represent the pointer. The graph system adds the new string “Car” to page P2 502 and stores the remaining characters “on”, “ard”, “ton”, and “yon” from the respective strings “Canon”, “Canard”, “Canton”, and “Canyon” to Page P3 503. According to embodiments, the graph system memory-maps pages from a file. This allows the graph system to make changes to the trie in memory storage and the changes are reflected on to the persistent store automatically.

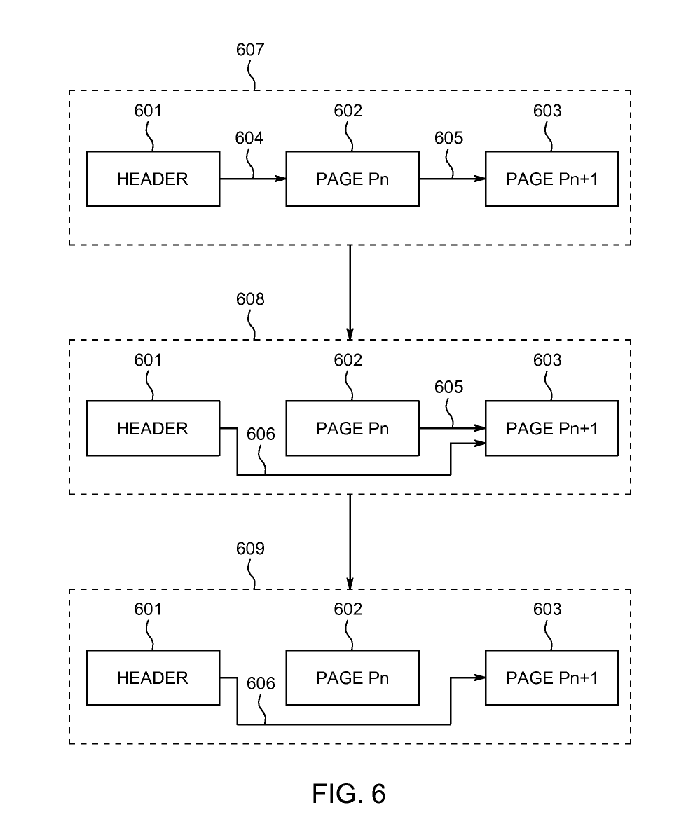

FIG. 6 illustrates an exemplary diagram for allocating a page, in accordance with embodiments. At step 607, a header page 601 includes a next page field that contains a page number of a following free page Pn 602, as indicated by an arrow 604. Page Pn 602 is chained to a subsequent free page Pn+1 603, as indicated by the arrow 605. At step 608, when a page needs to be allocated, the graph system reads page Pn 602 from the header page 601 and the subsequent free page Pn+1 603 that is chained to the page Pn 602, as indicated by an arrow 606. At step 609, the graph system updates the next page field of the header page 601 to indicate that the page number of the following free page becomes page Pn+1 603. Page Pn 602 is removed from a chain of free pages that can be allocated.

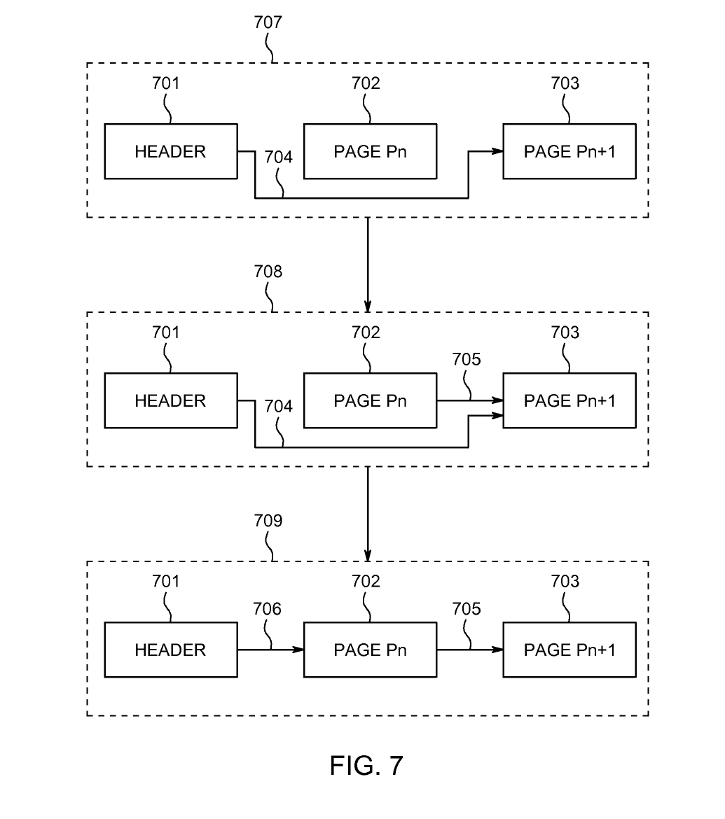

FIG. 7 illustrates an exemplary diagram for returning a newly freed page to a free page list, in accordance with embodiments. At step 707, a header page 701 includes a next page field that contains a page number of a following free page Pn+1 703, as indicated by an arrow 704. Page Pn 702 is removed from the chain of free pages. At step 708, when page Pn 702 is freed and returned to the free page list, the graph system updates a next free page field of page Pn 702 with the current free page Pn+1 703 from the header page 701, as indicated by an arrow 705. At step 709, the graph system updates the next free page field of the header page 701 with the freed page Pn 702, as indicated by an arrow 706.

Referring to FIGS. 5(a)-5(b), the graph system cleaves page P1 501 by allocating two free pages P2 502 and P3 503, and performs a copy-on-write operation when the new state of the cleaved page P1 501 is generated on pages P2 502 and P3 503. A copy-on-write operation enables the graph system to continue supporting read-access when a portion of a page is under modification. The graph system switches a pointer from page P1 501 to page P2 502. Page P1 501 is freed and the graph system returns page P1 501 to the list of free pages. The quick switch of a pointer when cleaving a page reduces the time of holding exclusive access (lock) to any page for the short duration when switching page pointers.

According to embodiments, the graph system allows every page to hold a cryptographic hash or other message digest of its contents. The message digest may be indicated by the message digest fields in Table 10. If the graph system performs a cleave operation and a modification operation simultaneously on page P1 501, the graph system may either fail the current modification or re-run the operation if the message digest does not match. In this way, the message digest detects two simultaneous operations and prevents the operations from overwriting each other.

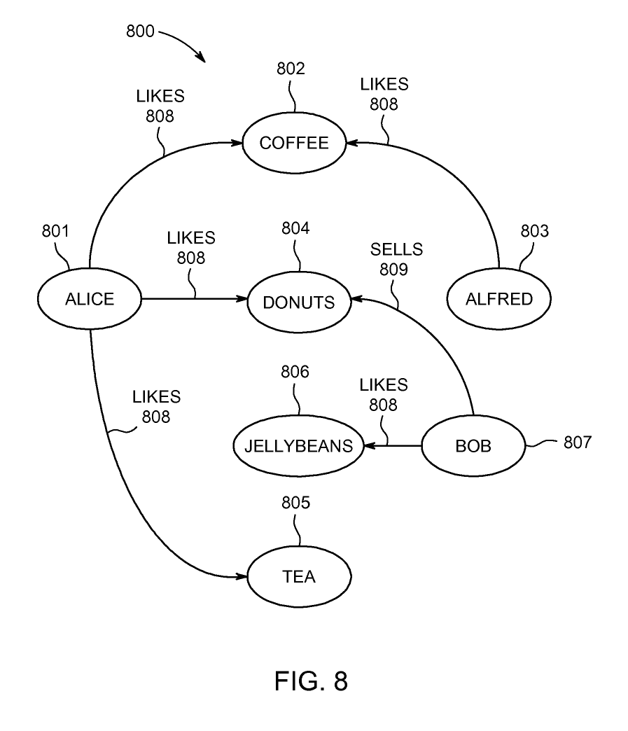

FIG. 8 illustrates exemplary graph 800, in accordance with embodiments. A graph 800 includes vertices 801-807 and edges 808-809 that provide directed links between vertices 801-807. For example, an edge labeled “likes” 808 is directed from a vertex labeled “Alice” 801 to a vertex labeled “Coffee” 802. The vertex “Alice” 801 is a subject, the edge “likes” 808 is a predicate, and the vertex “Coffee” 802 is an object. According to embodiments, the graph system stores two types of permutations of the subject-predicate-object relationship.

The first type of permutation is a subject-predicate-object string. In the above example, the graph system stores the first type permutation as a string such as:
Alice [symbol] likes [symbol] Coffee⊥.

As discussed earlier, the graph system uses a desired delimiter (e.g., the [symbol] symbol) to separate the subject “Alice”, the predicate “likes”, and the object “Coffee”. The ⊥ symbol indicates the end of a string. The first type of permutation allows the graph system to determine the vertex “Coffee” 802 that results from a direction of the edge “likes” 808 from the given vertex “Alice” 801.

The second type of permutation is a predicate-object-subject string. In the above example, the graph system stores the second type permutation as a string such as:
likes [symbol] Coffee [symbol] Alice⊥.

The second type of permutation allows the graph system to determine the vertex “Alice” 801 that results from an opposite direction of the edge “likes” 808 from the given vertex Coffee” 802.

The graph system stores the first and second types of permutations simultaneously as a set of strings. This allows the graph system to extract one or more strings and process queries without a need for explicit indexing. According to embodiments, the graph system maintains both the first and second types of permutations. This avoids the need to index and re-index graphs which is a significant barrier to performance.

According to embodiments, the graph system optionally stores a third type of permutation as an object-subject-predicate string. The third type of permutation allows the graph system to determine a type of relationship between two vertices in a graph. In the above example, the graph system may store the third permutation as follows:
Coffee [symbol] Alice [symbol] likes⊥.

The graph system may store each permutation in a separate file or as a separate linked structure from the header page.

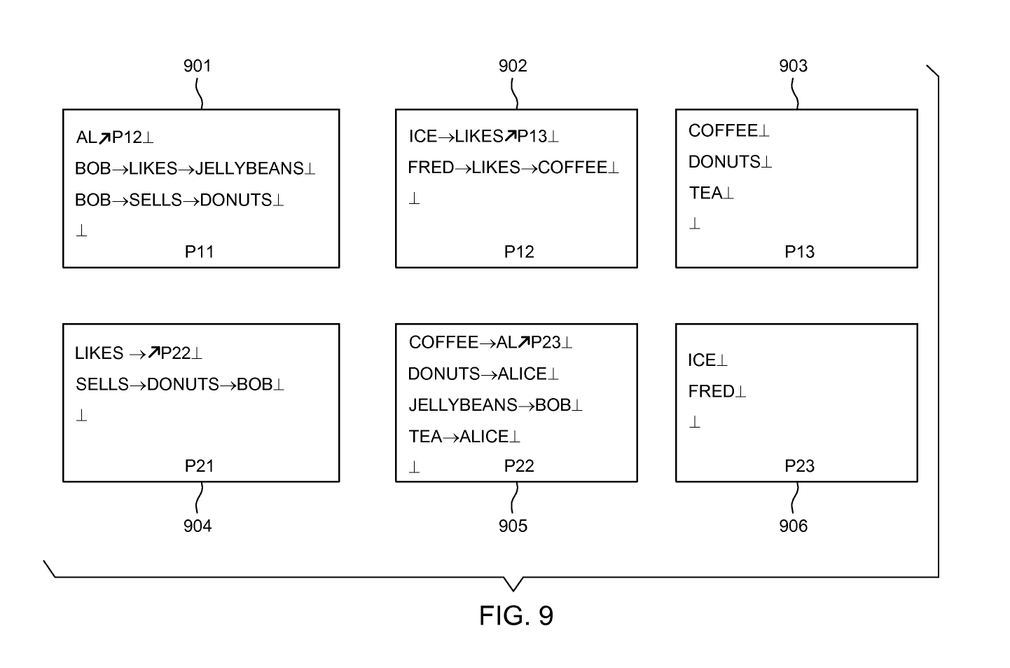

FIG. 9 illustrates exemplary pages that store a trie of the graph 800, in accordance with embodiments. The graph system stores the first type of permutation derived from the graph 800 (from FIG. 8) as a trie on page P11 901, page P12 902, and page P13 903. The first type of permutation includes the following strings:
Alice [symbol] likes [symbol] Coffee,
Alice [symbol] likes [symbol] Donuts,
   Alice [symbol] likes [symbol] Tea,
Alfred [symbol] likes [symbol] Coffee,
Bob [symbol] likes [symbol] Jellybeans, and
   Bob [symbol] sells [symbol] Donuts.

The graph 800 includes four strings “Alice [symbol] likes [symbol] Coffee”, “Alice [symbol] likes [symbol] Donuts”, “Alice [symbol] likes [symbol] Tea”, and “Alfred [symbol] likes [symbol] Coffee” that share a common prefix “A1”. The graph system stores the characters “A1” to page P11 901, as indicated by the string “A1 [symbol] P12” on page P11 901. The [symbol] P12 notation indicates that the remaining portion of the above four strings are stored to page P12 902. The remaining portions of the above four strings become:
ice [symbol] likes [symbol] Coffee,
ice [symbol] likes [symbol] Donuts,
ice [symbol] likes [symbol] Tea, and
fred [symbol] likes [symbol] Coffee.

Similarly, three of the above remaining portions “ice [symbol] likes [symbol] Coffee”, “ice [symbol] likes [symbol] Donuts”, and “ice [symbol] likes [symbol] Tea” share a common prefix “ice [symbol] likes”. Thus, the graph system stores the characters “ice [symbol] likes” to page P12 902, as indicated by the string “ice [symbol] likes [symbol] P13” on page P12 902. The [symbol] P13 notation indicates that the leftover strings “Coffee”, “Donuts”, and “Tea” are stored to page P13 903.

The graph system further stores the second type of permutation derived from the graph 800 (from FIG. 8) as another trie on page P21 904, page P22 905, and page P23 906. The second type of permutation includes the following strings:
likes [symbol] Coffee [symbol] Alice,
likes [symbol] Donuts [symbol] Alice,
likes [symbol] Tea [symbol] Alice,
likes [symbol] Coffee [symbol] Alfred,
likes [symbol] Jellybeans [symbol] Bob, and
sells [symbol] Donuts [symbol] Bob.

The graph 800 includes five strings “likes [symbol] Coffee [symbol] Alice”, “likes [symbol] Donuts [symbol] Alice”, “likes [symbol] Tea [symbol] Alice”, “likes [symbol] Coffee [symbol] Alfred”, and “likes [symbol] jellybeans [symbol] Bob” that share a common prefix “likes [symbol] ”. The graph system stores the characters “likes [symbol] ” to page P21 904, as indicated by the string “likes [symbol] [symbol] P22” on page P21 904. The [symbol] P22 notation indicates that the remaining portions of the above five strings are stored to page P22 904. The remaining portions of the above five strings become:
Coffe [symbol] eAlice,
Donuts [symbol] Alice,
Tea [symbol] Alice,
Coffee [symbol] Alfred, and
Jellybeans [symbol] Bob.

Similarly, two of the above remaining portions “Coffee [symbol] Alice” and “Coffee [symbol] Alfred” share a common prefix “Coffee [symbol] A1”. Thus, the graph system stores the characters “Coffee [symbol] A1” to page P22 904, as indicated by the string “Coffee [symbol] A1 [symbol] P23” on page P22 904. The [symbol] P23 notation indicates that the leftover strings “ice” and “fred” are stored to page P23 905.

According to embodiments, when performing an intersection on an exemplary query (e.g., likes=Coffee: likes=Jellybeans) the graph system evaluates the second type of permutation from pages P21 904, P22 905, and P23 906 and determines that there are no common characters after likes [symbol] Coffee and likes [symbol] Jellybeans as shown in on page P22 905. This allows the graph system to disregard page P23 906 from evaluation. For an intersection of multiple clauses, the more clauses there are in a query, the lesser the chance of a common character after the clause and the faster the query evaluation.

According to embodiments, the graph system models the graph query language after arithmetic expressions and evaluates the expressions similarly. The graph system changes an infix expression form (e.g., 2+2) to a postfix expression form (e.g., 2 2+) based on a shunt yard algorithm, in accordance with embodiments. The graph system evaluates the postfix expression form into a lazy evaluation structure, also known as a cursor. This allows for returning a small result set from a large result set.

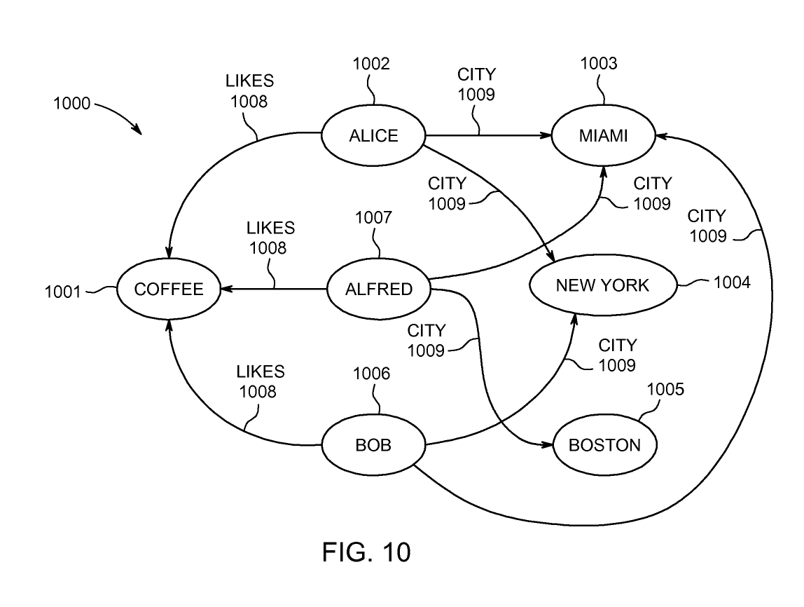

FIG. 10 illustrates exemplary graph 1000, in accordance with embodiments. Graph 1000 includes vertices 1001-1007 and edges 1008-1009 that provide directed links between vertices 1001-1007. For example, an edge labeled “likes” 1008 is directed from a vertex labeled “Alice” 1002 to a vertex labeled “Coffee” 1001.

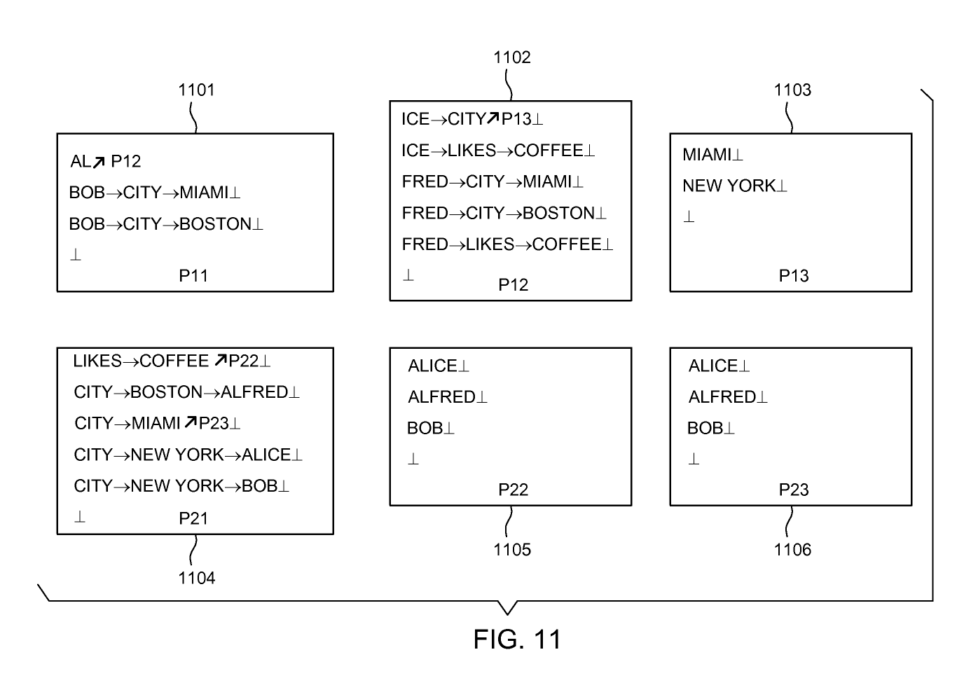

FIG. 11 illustrates exemplary pages that store a trie of the graph 1000, in accordance with embodiments, stores the first type of permutation. The graph system stores the first type of permutation derived from the graph 1000 (from FIG. 10) as a trie on page P11 1101, page P12 1102, and page P13 1103. The graph system further stores the second type of permutation derived from the graph 1000 as another trie on page P21 1104, page P22, 1105, and page P23 1106. According to embodiments, the graph system evaluates a given query expression likes=Coffee>city into a cursor that may be represented as follows:
outVertex(inVertex(likes, Coffee), city)

Referring to the above query expression, the inVertex represents a vertex that has an edge labeled “likes” coming into a vertex labeled “Coffee”. The outVertex represents a vertex that has an edge labeled “city” that originates from the vertex “Coffee”.

The graph system evaluates the inVertex(likes, Coffee) expression of the above cursor by looking up the second permutation of the trie, i.e., pages P21 1104, P22 1105, and P23 1106. The graph system determines a first vertex that points into the vertex “Coffee” on any edge labeled “likes” on page P21 1104. The graph system follows the string likes [symbol] Coffee [symbol] P22⊥ on page P21 1104 to page P22 1105 and fetches the vertex “Alice” from page P22 1105. The graph system substitutes the result “Alice” of the inVertex(likes, Coffee) expression into the above cursor that becomes:
outVertex(Alice, city)

The graph system further evaluates the outVertex(Alice, city) expression by looking up the first permutation of the trie, i.e., pages P11 1101, P12 1102, and P13 1103. The graph system determines a second vertex that points out from the vertex “Alice” on any edge labeled “city” on pages P11 1101 and P12 1102. The graph system follows the string A1 [symbol] P12⊥ on page P11 1101 to page P12 1102, and follows the string ice [symbol] city [symbol] P13⊥ on page P12 1102 to page P13 1103. The graph system fetches the vertex “Miami” from page P13 1103 and returns the result “Miami”. To fetch a subsequent result, the graph system looks up page P13 1103 again and returns the subsequent result “New York”. Once the results of the outVertex(Alice, city) expression are exhausted, the graph system rolls back up one level of the query to evaluate the inVertex(likes, Coffee) expression and returns a subsequent result “Alfred” from page P23 1106. According to embodiments, since pages P22 1105 and P23 1106 contain a common content, the graph system compares the message digests as an optimization before comparing pages P22 1105 and P23 1106. According to embodiments, the message digests of the headers are compared as ordinary binary strings or long words, depending on size.

As illustrated in FIG. 10, the vertices “Alice” 1002, “Alfred” 1007, and “Bob” 1006 that have an associated edge “likes” 1008 directed to the vertex “Coffee” 1001, indicating that Alice, Alfred, and Bob like Coffee. Similarly, the vertex “Alice” 1002 has an associated edge “city” 1009 directed to the vertices “Miami” 1003 and “New York” 1004, indicating that Alice is associated with two cities—Miami and New York. The vertex “Alfred” 1007 has an associated edge “city” 1009 directed to the vertices “Miami” 1003 and “Boston” 1005, indicating that Alfred is associated with two cities—Miami and Boston. The vertex “Bob” 1006 has an associated edge “city” 1009 directed to the vertices “Miami” 1003 and “New York” 1004, indicating that Bob is associated with two cities—Miami and New York.

Given the above cursor expression, outVertex(inVertex(likes, Coffee), city), the graph system evaluates with a single fetch from the cursor to determine a first person who likes coffee and his/her first associated city, e.g., Alice and Miami. The graph system may subsequently evaluate the same cursor to determine the first person's second associated city, i.e., New York. In embodiments, the graph system evaluates four results for the above cursor expression to produce the first two persons who like Coffee and both associated cities of each of the first two persons. The graph system evaluates the results from the cursor only when desired, and only for a desired number of results. This allows the graph system to return a partial query result before the query expression is completely evaluated, regardless of an actual data size.

According to embodiments, the graph system accesses any position in a result set containing multiple results. For an exemplary query expression (e.g., Alfred>city), the graph system evaluates page P12 1102 and skips to either result “Miami” or “Boston”.

According to embodiments, a client of the graph system refers to a user, including, but not limited to, a person, an application program, and a system utility. Once the client receives a partial result for a query, the client may choose to fetch additional data by qualifying the start using the [seek:value] sub-expression for a subsequent set of results based on a seek clause. For an exemplary query expression (e.g., likes=Coffee[seek:Bob]>city>[seek:Miami]), a seek clause in the above query expression results in following the trie for an additional number of characters enabling skipping earlier results.

In another example, in evaluating the query: likes=Coffee[seek:Joe\u0001]>city, the graph system can skip the result after Joe, where \u0001 refers to the Unicode character 0001. This allows the cursor to remain on the client, enabling the server to remain stateless. The partial result would include a query expression (the successor query) that would return the next partial block of results if sent back to the server. Similarly, a predecessor query may also be supplied. The state is held by the client based on the seek clause.

Since each level of recursion is evaluated only when required, a subsequent result for a graph query is only generated after a preceding result is consumed, and the evaluation of the data structure terminates when the partial result is returned to the client. The graph system waits for a result to be consumed before evaluating a subsequent result, thus providing near zero latency. This is known as a pipelining effect, and data is not moved until consumption. From the viewpoint of the server, there is no state and every query or portion thereof is independent.

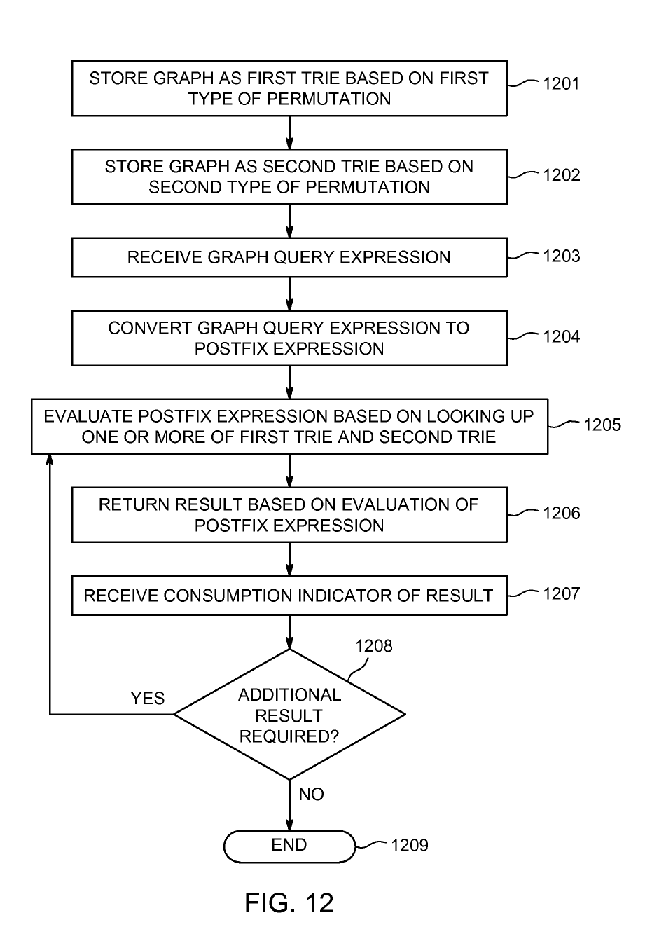

FIG. 12 illustrates an exemplary process of querying a graph, in accordance with embodiments. The graph system stores a graph as a first trie based on a first type of permutation at 1201. In embodiments, the first trie includes a first set of strings that are in an exemplary form:
subject [symbol] predicate [symbol] object⊥.

The predicate is an edge that is directed from the subject vertex to the object vertex.

The graph system stores the graph as a second trie based on a second type of permutation at 1202. In embodiments, the second trie includes a second set of strings that are in an exemplary form:
predicate [symbol] object [symbol] subject⊥.

The graph system receives a graph query expression at 1203. The graph system converts the graph query expression to a postfix expression at 1204. The graph system evaluates the postfix expression based on looking up one or more of the first trie and the second trie at 1205. The graph system returns a result based on the evaluation of the postfix expression at 1206. Since every partial query and subsequent refinements or continuations are independent queries, the server remains stateless. A technical effect of the graph system and method provides a lazy evaluation that evaluates a graph only when necessary, thus saves computing space. Furthermore, the lazy evaluation provides a predictable result return time and a consistent computing performance characteristic for a search query.

Implementation of lazy evaluation returns a small result set from a large results set. Since each level of recursion is evaluated only as it is needed, data is only generated as it is consumed and the evaluation of the data structure can terminate when consumption is completed. In querying a large graph, lazy evaluation generates a light cursor that stays on the client side. When a first result in response to a graph query is required, graph system 100 evaluates the light cursor and returns the first result. If a second result is required, the system then proceeds to evaluate the second result. This is known as a pipelining effect. Graph system 100 waits for a result to be consumed before evaluating a subsequent result, thus providing the illusion of zero latency. In this case, data is not moved until consumption.

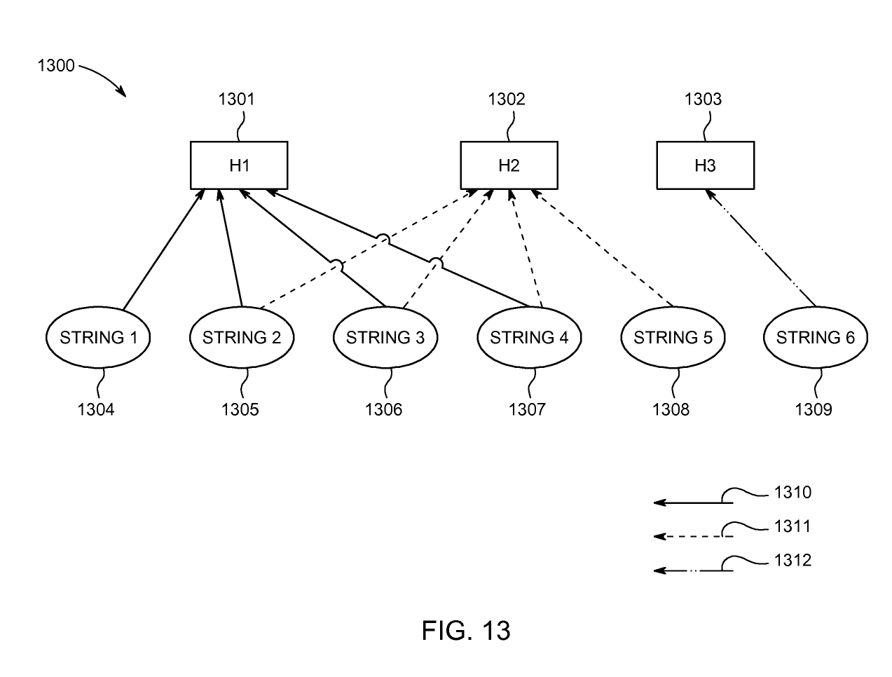

FIG. 13 illustrates an exemplary diagram of graph system 1300 for storing large graph data across multiple hosts, in accordance with embodiments. The graph system 1300 may distribute and store a graph over three hosts H1 1301, H2 1302, and H3 1303. Although FIG. 13 illustrates only three hosts, it is understood that the graph system 1300 can include any number of hosts. For example, the graph system 1300 stores data from the graph 800 (in FIG. 8) over hosts H1 1301, H2 1302, and H3 1303. The graph system 1300 stores strings for the first and second types of permutations derived from the graph 800 as follows:

string 1 (1304): Alice [symbol] likes [symbol] Coffee likes [symbol] Coffee [symbol] Alice

string 2 (1305): Alice [symbol] likes [symbol] Donuts likes [symbol] Donuts [symbol] Alice

string 3 (1306): Alice [symbol] likes [symbol] Tea likes [symbol] Tea→Alice

string 4 (1307): Alfred [symbol] likes [symbol] Coffee likes [symbol] Coffee [symbol] Alfred

string 5 (1308): Bob [symbol] likes [symbol] Jellybeans likes [symbol] Jellybeans [symbol] Bob

string 6 (1309): Bob [symbol] sells [symbol] Donuts sells [symbol] Donuts [symbol] Bob

Host H1 1301 stores strings 1-4 1304-1307 as indicated by an arrow 1310. Host H2 1302 stores strings 2-5 1305-1308, as indicated by an arrow 1311. Host H3 1303 stores string 6 1309, as indicated by an arrow 1312. According to embodiments, the graph system 1300 stores data with an overlap in two or more of hosts H1 1301, H2 1302, and H3 1303. For example, string 2 1303 is stored in host H1 1301 and H2 1302. When the graph system 1300 receives a graph query at one of the hosts (e.g., H1 1301), the graph system 1300 fetches and uses the header page of each of the hosts H1 1301, H2 1302, and H3 1303 to generate a result. This optimizes the graph query by merging all the data, i.e., strings 1-6 1304-1309 and eliminating any duplicate edges.

According to embodiments, the graph system caches pages if desired. For example, the graph system caches pages based on configuration or cache resource availability. Branch reduction and caching have cascading effects on the performance of distributed queries. As branches are reduced rapidly and early in the queries, the graph system only fetches data that is part of an eventual result. Caching eliminates most fetching on subsequent requests. According to embodiments, the graph system stores pages that are closer to the root of a trie across multiple hosts and caches these pages so that pages that are further away from the root of the trie pages remain un-fetched during a query. The pages that are closer to the root of a trie receives most of the queries. The further away from the root page, the fewer hits on the cache.

According to embodiments, the graph system updates a graph by either adding or removing an edge. When adding an edge, the graph system sends an add instruction regarding the added edge to one more hosts. In embodiments, the graph system replicates an edge over at least two hosts. When removing an edge, the graph system sends a remove instruction regarding the removed edge to every host in the graph system.

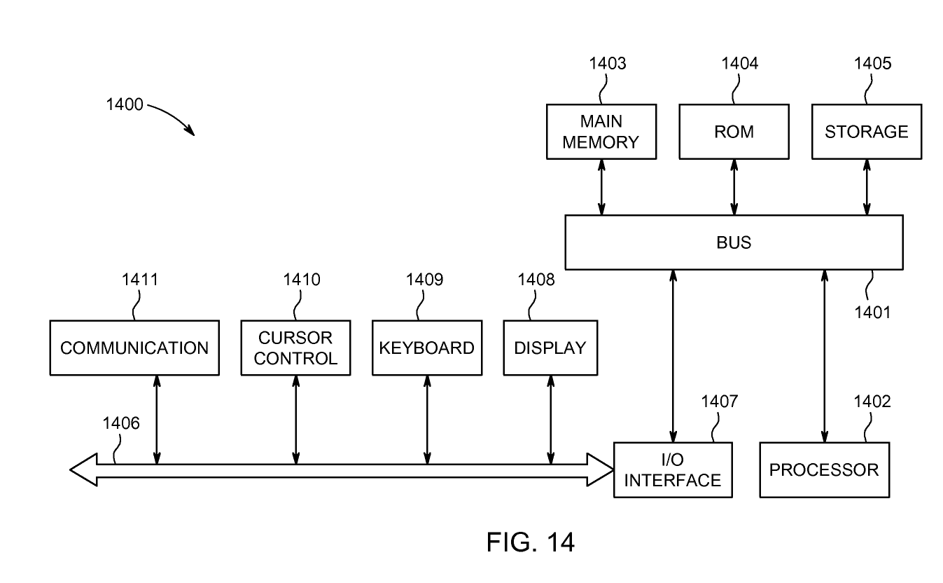

FIG. 14 illustrates exemplary computer architecture 1400 that may be used for the graph system, in accordance with embodiments. The exemplary computer architecture may be used for implementing one or more components described in the present disclosure including, but not limited to, the graph system. Embodiments of architecture 1400 includes a system bus 1401 for communicating information, and a processor 1402 coupled to bus 1401 for processing information. Architecture 1400 further includes a random access memory (RAM) or other dynamic storage device 1403 (referred to herein as main memory), coupled to bus 1401 for storing information and instructions to be executed by processor 1402. Main memory 1403 also may be used for storing temporary variables or other intermediate information during execution of instructions by processor 1402. Architecture 1400 may also include a read only memory (ROM) and/or other static storage device 1404 coupled to bus 1401 for storing static information and instructions used by processor 1402.

A data storage device 1405 such as a magnetic disk or optical disc and its corresponding drive may also be coupled to architecture 1400 for storing information and instructions. Architecture 1400 can also be coupled to a second I/O bus 1406 via an I/O interface 1407. A plurality of I/O devices may be coupled to I/O bus 1406, including a display device 1408, an input device (e.g., an alphanumeric input device 1409 and/or a cursor control device 1410).

The communication device 1411 allows for access to other computers (e.g., servers or clients) via a network. The communication device 1411 may include one or more modems, network interface cards, wireless network interfaces or other interface devices, such as those used for coupling to Ethernet, token ring, or other types of networks.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as querying nodes of large graphs distributed across multiple machines by applying a graph-query language that implements lazy evaluation techniques, as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated.

We claim:

1. A computer-implemented method, comprising:
receiving a graph query expression from a client, wherein a graph comprises a plurality of edges linking a plurality of vertices;
receiving a first request for evaluating the graph query expression;
evaluating a partial result set for the graph query expression; and
sending the partial result to the client;
the partial result including at least one of a successor query and a predecessor query,
wherein the successor query and the predecessor query enable evaluation of the graph query expression at a point in the graph query expression where the partial result evaluation terminated.

2. The computer-implemented method of claim 1, receiving the graph query expression includes converting an infix form of the graph query expression to a postfix form.

3. The computer-implemented method of claim 1, including storing the graph as a first trie that includes a first plurality of strings, wherein the first trie stores a first common prefix of two or more strings of the first plurality of strings on a first page, wherein each of the first plurality of strings includes a first vertex followed by an edge that is followed by a second vertex, and wherein the edge is directed from the first vertex to the second vertex.

4. The computer-implemented method of claim 3, including storing the graph as a second trie that includes a second plurality of strings, wherein the second trie stores a second common prefix of two or more strings of the second plurality of strings on a second page, wherein each of the second plurality of strings includes the second vertex followed by the edge that is followed by the first vertex.

5. The computer-implemented method of claim 4, including storing the graph as a third trie that includes a third plurality of strings, wherein the third trie stores a third common prefix of two or more strings of the third plurality of strings on a third page, wherein each of the third plurality of strings includes the second vertex followed by the first vertex that is followed by the edge.

6. The computer-implemented method of claim 1, wherein the graph query expression includes operations selected from at least one of edge hopping, a Boolean function, a set of edges of the plurality of edges that are from a vertex of the plurality of vertices, a triangular relationship, a range, and an alias.

7. The computer-implemented method of claim 1, including storing the graph across a plurality of hosts based on storing a common portion of the graph on two or more hosts of the plurality of hosts.

8. The computer-implemented method of claim 7, including providing a first result that includes the merger of data on each host of the plurality of hosts.

9. The computer-implemented method of claim 7, including adding an edge to the graph by replicating the edge over at least two hosts of the plurality of hosts.

10. The computer-implemented method of claim 8, including removing an edge from the graph by sending an instruction to the plurality of hosts.

11. A non-transitory computer readable medium containing computer-readable instructions stored therein for causing a computer processor to perform operations comprising:
receiving a graph query expression from a client, wherein a graph comprises a plurality of edges linking a plurality of vertices;
receiving a first request for evaluating the graph query expression;
evaluating a partial result set for the graph query expression; and
sending the partial result to the client;
the partial result including at least one of a successor query and a predecessor query, wherein the successor query and the predecessor query enable evaluation of the graph query expression at a point in the graph query expression where the partial result evaluation terminated.

12. The non-transitory computer-readable medium of claim 11, including instructions to cause the processor to perform the step of receiving the graph query expression by converting an infix form of the graph query expression to a postfix form.

13. The non-transitory computer-readable medium of claim 11, including instructions to cause the processor to perform the step of storing the graph as a first trie that includes a first plurality of strings, wherein the first trie stores a first common prefix of two or more strings of the first plurality of strings on a first page, wherein each of the first plurality of strings includes a first vertex followed by an edge that is followed by a second vertex, and wherein the edge is directed from the first vertex to the second vertex.

14. The non-transitory computer-readable medium of claim 13, including instructions to cause the processor to perform the step of storing the graph as a second trie that includes a second plurality of strings, wherein the second trie stores a second common prefix of two or more strings of the second plurality of strings on a second page, wherein each of the second plurality of strings includes the second vertex followed by the edge that is followed by the first vertex.

15. The non-transitory computer-readable medium of claim 14, including instructions to cause the processor to perform the step of storing the graph as a third trie that includes a third plurality of strings, wherein the third trie stores a third common prefix of two or more strings of the third plurality of strings on a third page, wherein each of the third plurality of strings includes the second vertex followed by the first vertex that is followed by the edge.

16. The non-transitory computer-readable medium of claim 11, wherein the graph query expression includes operations selected from at least one of edge hopping, a Boolean function, a set of edges of the plurality of edges that are from a vertex of the plurality of vertices, a triangular relationship, a range, and an alias.

17. The non-transitory computer readable medium of claim 11, wherein the computer processor performs the operations to store the graph across a plurality of hosts based on the computer processor stores a common portion of the graph on two or more hosts of the plurality of hosts.

18. The non-transitory computer readable medium of claim 17, wherein the computer processor performs the operations to provide the first result that comprises the computer processor merges each data on each host of the plurality of hosts.

19. The non-transitory computer readable medium of claim 17, wherein the computer processor performs the operations to add an edge to the graph by replicating the edge over at least two hosts of the plurality of hosts.

20. The non-transitory computer readable medium of claim 17, wherein the computer processor performs the operations to remove an edge from the graph by sending an instruction to the plurality of hosts.
